(19) United States
(12) Patent Application Publication
(10) Pub. No.: US 2020/0072186 A1
(43) Pub. Date: Mar. 5, 2020

(54) ROTOR BLADE FOR A WIND TURBINE AND WIND TURBINE

(71) Applicant: Wobben Properties GmbH, Aurich (DE)

(72) Inventors: Marcel KRUSE, Beverstedt (DE); Falk SPIETH, Aurich (DE)

(21) Appl. No.: 16/466,214

(22) PCT Filed: Sep. 18, 2017
(86) PCT No.: PCT/EP2017/073490

§ 371 Date: Jun. 3, 2019

(30) Foreign Application Priority Data
Dec. 5, 2016 (DE) 10 2016 123 412.5

(51) Int. Cl. F03D 1/06

(52) U.S. Cl. CPC F03D 1/0641; F05B 2240/302; F05B 2240/301; F03D 1/0675

(57) ABSTRACT

A rotor blade for a wind turbine, to a wind turbine having a tower, a nacelle and a rotor, and also to a wind farm. The rotor blade comprises an inner blade portion which extends in the longitudinal direction of the rotor blade starting from a rotor blade root, and a trailing edge segment which is arranged on the inner blade portion and intended for increasing the profile depth of the rotor blade along a portion in the rotor blade longitudinal direction. The rotor blade has a pressure-side surface and a suction-side surface which are each formed in certain regions from parts of the inner blade portion and of the trailing edge segment. At least one slot-like air inlet and/or air outlet which extends substantially in the rotor blade longitudinal direction is formed on the pressure-side and/or suction-side surface of the rotor blade in the region of the trailing edge segment. The rotor blade achieves a more efficient influence on the boundary layer.

### BACKGROUND

### Technical Field

The invention relates to a rotor blade for a wind turbine. The invention further relates to a wind turbine having a tower, a nacelle and a rotor, and also to a wind farm.

### Description of the Related Art

It is known in the prior art to improve the efficiency of a wind turbine via the design of the rotor blades on a wind turbine. One possibility of increasing the efficiency or performance capability of the wind turbine is to configure the profile of the rotor blade to have a large profile depth in the region of the rotor blade root. For this purpose, the profile depth, which is to be understood hereinbelow as meaning the length of the profile substantially perpendicular to the rotor blade longitudinal direction, that is to say the distance between a profile nose and a profile trailing edge of the rotor blade, should be configured to be as large as possible. The rotor blade root designates the region of the rotor blade by which the rotor blade is fastened to the rotor hub of the wind turbine. It is frequently the case that the maximum profile depth in such a rotor blade lies very close to the rotor blade root. Consequently, vortex generation is reduced and the efficiency of the wind turbine increased.

A further possibility of increasing efficiency consists in influencing the boundary layer, this gaining ever more importance on account of the increasing profile depths. On the suction side of the rotor blade, by virtue of the generally convex curvature of the suction-side surface, the air flow runs against a pressure gradient after passing the maximum curvature in the rear region of the rotor blade profile. This causes slowing of the air flow, with the result that the boundary layer loses kinetic energy. Under certain circumstances, the slowing of the air flow results in the boundary layer starting to separate from the surface of the rotor blade. A flow which is separated from the rotor blade surface results in turbulence, whereby the lift produced on the suction side reduces and the resistance thus increases. Influencing the boundary layer is intended in particular to avoid a situation in which the air flow separates from the surface of the rotor blade.

It is known from the prior art, such as DE 10 2011 050 661 A1, for example, to form the trailing edge obtusely in the root region of the rotor blade. Provided in the region of the trailing edge is a boundary layer suction system in the form of a row of holes extending along the trailing edge. The suctioned air is transported from the blade root in the direction of the blade tip via an air-channeling duct extending within the rotor blade in the longitudinal direction and discharged via a blow-out region on the trailing edge of the blade tip. This arrangement is cumbersome and requires both the provision of technically complex air inlets on the trailing edge, which readily endanger the stability, and the provision of at least one air-channeling duct. In addition, the influence on the boundary layer does not occur at the point of the pressure or suction side at which separation of the boundary layer occurs.

WO 2016/045656 A1 relates to a wind turbine rotor blade having an upper side, a lower side, a leading edge, a trailing edge, a hub fastening and a blade tip, wherein the wind turbine rotor blade is divided into a hub region, a central region and a blade tip region, and a root region from the hub fastening to the maximum blade depth (Smax) is defined, wherein a radially outwardly extending air-channeling duct for channeling suctioned air from a suction region to a blow-out region arranged in the blade tip region is provided within the wind turbine rotor blade, and boundary layer suctioning occurs, wherein the air is suctioned on the upper side of the wind turbine rotor blade, and a boundary layer fence is provided in the hub region close to the hub fastening in order to prevent a flow in the direction of the hub fastening.

EP 2 053 240 A1 discloses a wind turbine, comprising a rotor with a hub and rotor blades, and further comprising a boundary layer control system for the rotor blades, wherein a plurality of pressure chambers are arranged in the blade so as to be distributed over the length of the blade, wherein each pressure chamber is in communication with the outer side of the blade through one or more corresponding openings in the outer surface of the rotor blade, wherein furthermore a suction duct and a blowing duct extend inside the blade in order to supply a negative pressure or a positive pressure to the pressure chamber, wherein each pressure chamber is connected to at least one of the ducts through an air duct in which there is arranged an actively operable valve which is connected to a control unit in order to selectively bring the pressure chamber into communication with the duct or the ducts or disconnect it therefrom so as to blow air out of the pressure chamber or suck air into the pressure chamber through the corresponding opening(s) in the blade surface.

WO 2007/035758 A1 discloses a blade (such as a wind turbine blade) which is configured in such a way that it is fastened adjacent to a rotatable hub, wherein the blade defines: a fluid inlet which is arranged adjacent to a proximal portion of the blade; a fluid outlet which is arranged adjacent to a distal portion of the blade; and a centrifugal flow duct which extends within an inner part of the blade between the fluid inlet and the fluid outlet. The fluid inlet is preferably in gaseous communication with the fluid outlet via the centrifugal flow duct, and the blade is configured such that, when the blade is rotated about the hub at a particular velocity, fluid, which is drawn into the fluid inlet, is expelled through the centrifugal flow duct and out of the fluid outlet. The fluid is preferably compressed when it moves through the central flow duct.

WO 2009/144356 A1 discloses a wind generator blade with hyper-supporting elements on the leading edge and/or on the trailing edge (the latter having a high relative thickness), which elements are situated in the root zone so as to improve the aerodynamic behavior and therefore the quantity of energy which from the wind by comparison with conventional blades with a cylindrical or oval root region.

### BRIEF SUMMARY

Provided is a rotor blade for a wind turbine, having an inner blade portion which extends in the longitudinal direction of the rotor blade starting from a rotor blade root, and having a trailing edge segment arranged on the inner blade portion and intended for increasing the profile depth of the rotor blade along a portion in the rotor blade longitudinal direction, wherein the rotor blade has a pressure-side surface and a suction-side surface which are each formed in certain regions from parts of the inner blade portion and of the trailing edge segment.

Provided is a rotor blade for a wind turbine having at least one slot-like air inlet and/or air outlet which extend or extends substantially in the rotor blade longitudinal direction are or is formed on the pressure-side and/or suction-side surface of the rotor blade in the region of the trailing edge segment.

The invention here makes use of the finding that, with the aid of a slot-like air inlet and/or air outlet on the pressure-side and/or suction-side surface of the rotor blade, there is formed at least one suctioning or blow-out region which advantageously influences a boundary layer flowing in the direction of the profile depth of the rotor blade. By comparison with boundary layer suctioning in the region of the trailing edge of a trailing edge segment, the air flow is influenced in the region of the rotor blade in which it achieves the greatest effect. Moreover, by contrast with the known holes, the configuration according to the invention of the air inlet or air outlet as a slot or gap causes an increased suction effect or blow-out effect on the flowing-past boundary layer of the air flow. Moreover, no holes or structural modifications on the inner blade portion that can cause stability problems are required.

A slot-like air inlet and/or outlet is to be understood as meaning a slot or gap in the surface of the rotor blade on its pressure-side or suction-side surface, the dimension of which slot or gap in the rotor blade longitudinal direction being greater than in the direction of the profile depth. The dimensions of the air inlets and/or air outlets in the rotor blade longitudinal direction are preferably greater by a multiple than in the direction of the profile depth. In one embodiment, the dimension in the rotor blade longitudinal direction is at least twice as large as the dimension in the direction of the profile depth. In another embodiment, the dimension in the rotor blade longitudinal direction is at least 10 times greater, in particular at least 20 times greater, particularly preferably at least 50 times greater, than the dimension in the direction of the profile depth.

In a preferred development, in each case at least one slot-like air inlet and/or air outlet is arranged on the pressure-side and suction-side surface of the rotor blade. The boundary layer is thus influenced both on the pressure-side and suction-side surface of the rotor blade. The configuration of an air inlet or air outlet in the form of a slot or gap in the region of the trailing edge segment is possible since the forces acting on the rotor blade in the region of the blade root mainly act on the inner blade portion of the rotor blade, which portion, however, has no structural impairment caused by the slots or gaps in the trailing edge segment. An air inlet or air outlet can be formed from a single slot or gap. In another embodiment, an air inlet or air outlet is formed from a plurality of individual slots or gaps on the surface of the rotor blade. They are preferably arranged next to one another so as to extend in a line approximately in the rotor blade longitudinal direction.

A development of the rotor blade provides that each air inlet and/or air outlet is formed directly in the transition region from the inner blade portion to the trailing edge segment. The upper side of the trailing edge segment, which forms a region of the suction-side surface, and the underside of the trailing edge segment, which forms a region of the pressure-side surface of the rotor blade, are designed to be shortened toward the inner blade portion in a simple manner. This results in an interruption in the suction-side and pressure-side surface of the rotor blade by an edge on the upper side and underside of the trailing edge segment that is set back on the inner blade portion. Upon attachment of the trailing edge segment to the inner blade portion, the edges of upper side and underside of the trailing edge segment are thus arranged at a spacing from a respectively assigned region of the inner blade portion. In an alternative embodiment, the slot-shaped air inlet and/or air outlet is formed in any desired region of the upper side or underside of the trailing edge segment. In another embodiment, only air inlets or air outlets are provided on the suction-side and pressure-side surface.

With preference, the air inlet is arranged on the pressure-side surface of the rotor blade, and the air outlet is arranged on the suction-side surface of the rotor blade. Air inlet and air outlet, which are preferably coupled to one another in a fluid-channeling manner, are thus arranged on mutually opposed sides of the rotor blade. During operation of the wind turbine, there preferably occurs an automatically flowing air flow, also termed compensating flow, from the air inlet on the pressure side to the air outlet on the suction side of the rotor blade. The air inlet and the air outlet are arranged on the rotor blade and configured in such a way that, upon rotation of the rotor and given the pressure conditions which thus arise, a “natural” compensating flow is generated from the air inlet through the trailing edge segment, also termed rear box, to the air outlet. An automatic air flow is to be understood in the present case as meaning the occurrence of an air flow from the air inlet to the air outlet solely on account of the centrifugal force or the rotary movement of the rotor and of the rotor blades arranged thereon without the use of any components and devices which assist the generation of a forced flow.

The air inlet and/or air outlet preferably extend or extends substantially over the entire length of the trailing edge segment. A gap or slot is thus preferably formed at least in the surfaces of the rotor blade in the rotor blade longitudinal direction along which the trailing edge segment extends. In one embodiment, such a slot-like air inlet and/or air outlet is formed from a plurality of individual slots or gaps which are arranged next to one another in the rotor blade longitudinal direction. In another embodiment, slots or gaps each directly adjacent to one another have an offset in the direction of the profile depth. However, the total number of slots or gaps extends over the entire length of such an air inlet or air outlet, in each case substantially in the rotor blade longitudinal direction. The gaps or slots arranged offset to one another have mutually superimposed or overlapping end regions, the individual slots or gaps would be arranged congruently in a row. In other embodiments, other arrangements of slots, for example parallel slots at an angle to the rotor blade longitudinal direction, are also possible.

In one embodiment of the invention, the trailing edge segment is preferably arranged on the inner blade portion in such a way that an air inlet and/or air outlet duct for a directed air flow are or is formed on the air inlet and/or air outlet. In the case of a plurality of individual slots, each individual gap or slot of an air inlet and/or air outlet is preferably equipped with an air inlet duct or an air outlet duct. Corresponding air inlet and air outlet ducts on the rotor blade are preferably each connected to one another via a separate air-channeling duct. By means of the air-channeling duct, the air removed on the pressure-side surface is transferred in the direction of the air outlet on the suction-side surface of the rotor blade. The air-channeling duct, which couples the air inlet duct and the air outlet duct to one another, extend substantially transversely to the rotor blade longitudinal direction. Each air inlet duct and/or air outlet duct preferably has channeling elements, such as baffle plates, for example, in the region of a respective air inlet or air outlet, with the result that the directed guidance of the air flow flowing through the trailing edge segment is further improved.

In one embodiment, the air-channeling duct does not extend perpendicular to the profile of the rotor blade or transversely to the rotor blade longitudinal direction, but extends at least partially radially outward, that is to say in the direction from the blade root to the rotor blade tip. By virtue of the component in the radial direction, a centrifugal force acts on the air in the air-channeling duct during a rotation of the rotor and causes directed guidance of the air situated in the air-channeling duct.

In a preferred development of the rotor blade, the air inlet duct and/or air outlet duct are or is configured to deflect the air flow in the region of the air inlet and/or air outlet substantially parallel to the respectively adjoining outer surface of the inner blade portion. On the suction-side surface of the rotor blade, an additional air flow is blown out in a turbulence-free manner boundary layer flowing preferably in the direction of the profile depth of the rotor blade. The air flow is preferably discharged or blown out via the air outlet duct, preferably in the direction of the air flow flowing along the suction-side surface of the rotor blade. Consequently, the boundary layer is influenced in a simplified manner on the suction-side surface of the rotor blade. In one embodiment of the invention, the air flow is suctioned in the flow direction on the pressure-side surface of the rotor blade.

In a further design, the boundary layers are influenced precisely in the inverse direction; specifically, the boundary layer on the suction-side surface that is at the point of detaching is suctioned via the air inlet duct and correspondingly discharged along the pressure-side surface. The air guidance must be ensured in this design counter to the natural pressure gradient by suitable means.

Furthermore, the air inlet duct and/or air outlet duct preferably have or has, on the air inlet and/or air outlet, a widening or narrowing cross section in the flow direction of the air flow flowing through the ducts. In one embodiment of the invention, the inner blade portion preferably has an approximately annular or elliptical cross section. Here, the shape of the cross section is preferably dependent on the spacing of the inner blade portion from the rotor blade root of the rotor blade. In the region close to the blade root, the inner blade portion preferably has a cross section approximating to an annular shape. The greater the spacing from the blade root, the more the cross section of the inner blade portion changes to an elliptical shape.

A further embodiment of the rotor blade according to the invention provides that the rotor blade has a fan or compressor, wherein the air inlet and the air outlet on the rotor blade communicate in a fluid-channeling manner with the fan or compressor for forced air guidance through at least the trailing edge segment. The fan or compressor is particularly configured to support the “natural” compensating flow from the pressure-side surface in the direction of the suction-side surface or even to reverse the air flow in the opposite direction. With the aid of the fan or compressor on the rotor blade, it is possible to generate an air flow from the suction-side surface in the direction of the pressure-side surface of the rotor blade. By means of the fan or compressor, there occurs a positive guidance of the air flow in the trailing edge segment substantially parallel to the profile depth of the rotor blade. The air thus flows perpendicular to the rotor blade longitudinal direction. In one embodiment of the invention, there is provision that the air flow within the trailing edge segment flows, alternatively or optionally, over a portion of the rotor blade in the rotor blade longitudinal direction. In other words, the air flow flows at least in certain portions from the blade root in the direction of the blade tip and/or in the opposite direction.

In one embodiment of the rotor blade according to the invention, the fan or compressor is arranged in the inner blade portion of the rotor blade, wherein preferably the inner blade portion has, in its structural body, air passage openings and/or air-channeling ducts for the fluid-channeling connection between the fan or the compressor and the air inlet and/or air outlet. In particular, a fan or compressor which is arranged in the inner blade portion of the rotor blade and by means of which the rotor blade heating occurs can optionally be designed, in addition to heating the rotor blade, to allow the air flow from the air inlet in the direction of the outlet of the trailing edge segment. The air inlet on the rotor blade portion is preferably connected in a fluid-channeling manner, in particular air-channeling manner, to the suction side of the fan or compressor, and the air outlet is connected in a fluid-channeling manner, in particular air-channeling manner, to the pressure side of the fan or compressor. For the fluid-channeling connection of the fan or compressor arranged in the inner blade portion to the air inlet and the air outlet on the trailing edge segment, there are provided one or more air passage openings or air-channeling ducts which penetrate the structural body of the inner blade portion with its preferably annular or elliptical cross section. In the present case, the rotor blade has air-channeling ducts which implement positive guidance of the flowing air both in the rotor blade longitudinal direction and transversely to the rotor blade longitudinal direction.

One embodiment of the rotor blade according to the invention provides that a fan or compressor is arranged in the trailing edge segment of the rotor blade. Consequently, the structural design of the inner blade portion and the air guidance between the air inlet and the air outlet on the trailing edge segment is simplified. Instead of possible air passage openings and/or air-channeling ducts, which weaken the structural body of the inner blade portion, only a relatively small opening is provided in the structural body for supplying power to the fan or compressor arranged in the trailing edge segment of the rotor blade. The fan or compressor arranged in the trailing edge segment of the rotor blade is connected by its suction side to the air inlet on preferably the suction-side surface of the rotor blade. Furthermore, the fan or compressor is connected in a fluid-channeling manner by its pressure side to the air outlet on the pressure-side surface of the rotor blade. Use is preferably made of a fan or compressor which is configured to generate an air flow in both directions within the air-channeling ducts connected to the fan or compressor.

An axial fan or axial compressor is preferably used. In another embodiment of the invention, a radial fan or radial compressor is used. By contrast with axial fans or compressors, radial fans or radial compressors make it possible to compensate for relatively large pressure losses in air-channeling ducts having relatively long duct lengths for an air flow guided at least over a portion in the rotor blade longitudinal direction. Alternatively to the fan or the compressor, other known means for air guidance can also be provided in other embodiments.

In one embodiment of the invention, suctioning of the boundary layer occurs on the suction-side and pressure-side surface of the rotor blade via the slot-like air inlets on thus mutually opposed sides of the rotor blade. The air outlet is at a remote region from the air inlets, such as, for example, the trailing edge of the trailing edge segment or the blade tip.

In one embodiment of the rotor blade, each trailing edge segment is preferably composed at least of a first and a second segment portion. The subdivided configuration of the trailing edge segment into a plurality of, preferably at least two, three or four, segment portions facilitates the mounting of the trailing edge segment on the inner blade portion of the rotor blade to be produced. At least one segment portion of the trailing edge segment can be arranged, for example, on the inner blade portion during the manufacture of the inner blade portion. In one embodiment of the invention, the plurality of segment portions are arranged next to one another in the longitudinal direction of the rotor blade, the trailing edge segment, also termed rear box, is thus formed from segment portions arranged adjacently next to one another in the direction of extent of the rotor blade.

In an alternative embodiment, there is provision to subdivide the trailing edge segment into a segment portion which can be connected to the inner blade portion and into at least one further segment portion which has the trailing edge of the trailing edge segment. The segment portion which can be or is to be connected to the inner blade portion forms a foot segment. The segment portion/portions having the trailing edge then preferably forms/form the head segment of the trailing edge segment. A segment portion formed as a foot segment preferably makes fitting possible ex works without increasing the dimensions of the inner blade portion in the direction of the profile depth.

Advantageously, the segment portion formed as a foot segment has, for each segment portion forming the head segment, a separate subdividing plane in which the head segment or segments can be coupled to the foot segment. The provision of separate subdividing planes for each head segment facilitates the assignment to a region of the foot segment that has the respective subdividing plane.

According to an alternative advantageous embodiment, the foot segment has, for a plurality of or all head segments, a continuous subdividing plane in which the respective head segments can be coupled to the foot segment. A continuous subdividing plane which extends over a plurality or all assignment regions between foot segment and head segments offers the advantage that a plurality of segment portions can be coupled behind one another to the foot segment on the entire subdividing plane, and mutually support one another in so doing. As a result, the effort for fixing the position of the plurality of head segments is considerably reduced.

According to a further preferred embodiment of the invention, the one subdividing plane or the plurality of subdividing planes is or are arranged in such a way that the maximum profile depth of the rotor blade is 4 m or less if the foot segment is connected to the rotor blade. By virtue of the fact that a longitudinal division is chosen which leads to a maximum profile depth in the aforementioned range, the transportability of the rotor blade together with premounted foot segment of the trailing edge segment is considerably improved.

The subdividing planes are preferably oriented substantially in the longitudinal direction of the rotor blade axis. An angle in a range of 30° or less is preferably defined between the rotor blade axis and the subdividing plane or planes.

According to a further preferred embodiment, the foot segment and the head segment or segments can be coupled to one another in a form-fitting manner.

According to a preferred development of the invention, the trailing edge segment is connected to the inner blade portion via at least a first and a second fastening element, wherein preferably the fastening elements are arranged at spacings from one another in the rotor blade longitudinal direction. The first fastening element is preferably arranged in the direct vicinity of the blade root. The at least one further, that is to say the second, fastening element is arranged approximately at the opposite end of the trailing edge segment. Depending on whether the trailing edge segment is formed from a plurality of segment portions, at least one fastening element per segment portion or preferably two fastening elements per segment portion are provided for fastening to the inner blade portion. The connection of the trailing edge segment no longer occurs via the upper side or underside of the trailing edge segment, but via the fastening elements, with the result that, in the transition region from the inner blade portion to the trailing edge segment, the air inlet and/or air outlets can take the form of slots or gaps on the suction-side and pressure-side surfaces of the rotor blade. The trailing edge segment preferably forms a receptacle for the at least first and the second fastening element, said receptacle being shielded from the outside of the trailing edge segment. Consequently, the fastening elements are protected from environmental influences and additionally do not adversely affect the aerodynamics of the rotor blade.

In a preferred embodiment of the invention, the at least one fastening element preferably has at least one ribbed body which stiffens the trailing edge segment, wherein the ribbed body is preferably connected to the outer surface of the inner blade portion and to the inner side of the trailing edge segment via at least one, two or more fastening points. The trailing edge segment is stiffened with the aid of the ribbed body in such a way that the upper side assigned in particular to the suction side on the rotor blade and the underside of the trailing edge segment assigned to the pressure side on the rotor blade are preferably arranged so as to be dimensionally stable with respect to one another. The ribbed body of the fastening element that is arranged in the receptacle of the trailing edge segment is in each case preferably fastened via at least two fastening points to the outer surface of the inner blade portion and to the respectively assigned inner surfaces of upper side and underside of the trailing edge segment. The ribbed body is preferably connected to the correspondingly assigned surface regions of inner blade portion and trailing edge segment by means of a force-fitting connection or an integrally bonded connection.

In one embodiment of the invention, connecting ribs or connecting webs assigned to the connecting surfaces of inner blade portion and trailing edge segment are arranged on the ribbed body and by means of which the connecting region between the fastening element and the component to be coupled thereto is preferably enlarged. As a result, the structural connection between the trailing edge segment and the inner blade portion of the rotor blade is further improved.

In a preferred embodiment, the first and the second ribbed body each have a connecting surface or edge which extends, for example, over the entire profile depth of the trailing edge segment and/or is fastened within the receptacle to the upper side and/or the underside of the trailing edge segment. The length of the respective stiffening rib along the profile ensures, on the one hand, stiffening of the trailing edge segment and, on the other hand, uniform load transmission. The fastening of this edge within the trailing edge segment protects the attachment from external influences.

In a particularly preferred embodiment, the first and the second ribbed body have or has one or more transverse edges which is or are adapted to the geometry of the inner blade portion. Here, the transverse edge extends from the upper side to the underside of the trailing edge segment portion. Adapting the transverse edge to the geometry of the inner blade portion ensures an accurately fitting attachment of the fastening element to the inner blade portion. The transverse edge can thus further strengthen the connection of the inner blade portion and of the trailing edge segment portion. A firm connection between the transverse edge or an adhesive foot and the inner blade portion is thus likewise possible.

The first ribbed body and the second ribbed body are preferably fastened to their connecting surfaces via an integrally bonded and/or form-fitting connection. Here, the ribbed bodies and the connecting surfaces are each connected to one another on a common contact surface. Here, the respective connecting technique is adapted in dependence on the occurring loads and the geometric design of the trailing edge segment and inner blade portion. A particularly firm connection is achieved by a combination of a form-fitting and integrally bonded connection.

In a preferred embodiment, the integrally bonded connection comprises an adhesive connection, in particular an adhesive connection comprising a two-component adhesive. Here, such an adhesive connection has the advantage that a force introduction can be introduced even with different materials, such as, for example, a force introduction from a glass-fiber-reinforced plastic to an aluminum component. The cross sections of the connecting surfaces and of the ribbed bodies are not reduced and the stress distribution occurs uniformly. In addition, an adhesive connection makes it possible to compensate for fitting inaccuracies which can occur during manufacture.

In a particularly preferred embodiment, the force-fitting connection comprises a rivet connection, screw connection, bolt connection and/or loop connection. Here, such connection techniques are advantageous under a high loading on the connecting points. Here, a rivet, screw and bolt connection has the advantage that they can be transmit high loads and the required connecting elements can be manufactured with a high degree of quality. As a result, a high degree of safety is achieved in the region of the connection. Moreover, such a connecting technique is cost-effective. Here, in the case of a high point load introduction, a loop connection by dividing the load into two strands is particularly advantageous.

The first ribbed body and the first connecting surface and the second ribbed body and the second connecting surface are preferably arranged plane-parallel to one another. The plane-parallel arrangement provides a sufficiently large area via which the respective ribbed bodies and connecting surfaces produce a connection.

The invention further relates to a wind turbine having a tower, a nacelle and a rotor. A rotor blade connected to the rotor is designed according to one of the above-described preferred embodiments. Such a rotor blade makes it possible to influence a boundary layer on the rotor blade, with the result that the efficiency of the wind turbine can be improved in a simple manner.

Furthermore, the invention also relates to a wind farm having a plurality of wind turbines which are designed according to one of the above-described preferred embodiments of the invention.

The preferred embodiments or developments described in respect of the rotor blade according to the invention are simultaneously also preferred embodiments of the wind turbine according to the invention and of the wind farm according to the invention.

### BRIEF DESCRIPTION OF THE SEVERAL VIEWS OF THE DRAWINGS

The invention will be described in more detail below on the basis of one possible exemplary embodiment with reference to the appended figures, in which:

FIG. 1 shows a wind turbine according to the present invention;

FIG. 2 shows a perspective view of a portion of a rotor blade according to the invention according to a first exemplary embodiment;

FIG. 3 shows a perspective view of a portion of a rotor blade according to the invention in a second exemplary embodiment;

FIG. 4 shows a view of the rotor blade according to FIG. 3 in section under natural air flow;

FIG. 5 shows a view of the rotor blade according to FIG. 3 under a forced air flow generated by means of a fan or compressor; and

FIGS. 6a to 6c show views of possible patterns of air inlets or air outlets on a suction-side or pressure-side surface of a rotor blade.

### DETAILED DESCRIPTION

Although certain features of preferred embodiments are described only with respect to individual exemplary embodiments, the invention also extends to the combination of single features of the different exemplary embodiments with one another.

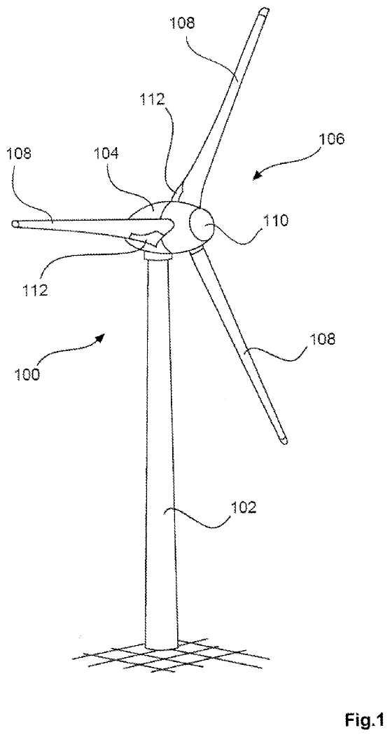

FIG. 1 shows a wind turbine 100 having a tower 102 and a nacelle 104. A rotor 106 having three rotor blades 108 and a spinner 110 is arranged on the nacelle 104. During operation, the rotor 106 is set in a rotational movement by the wind and thereby drives a generator (not shown) in the nacelle 104.

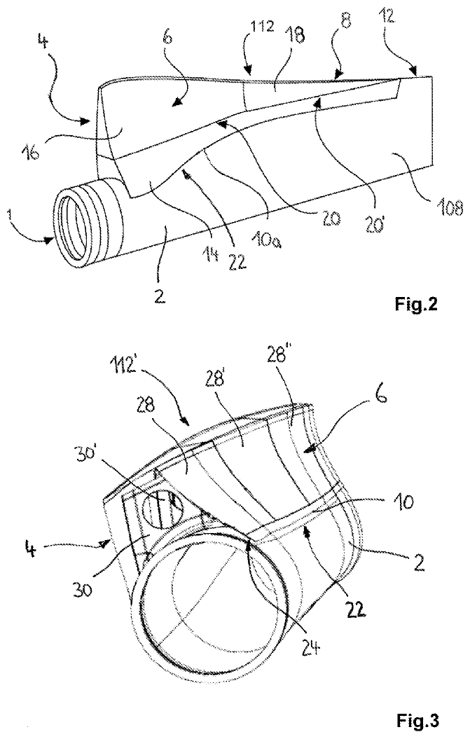

The rotor blades 108 each have a trailing edge segment 112, 112′ by means of which they are formed as close-fitting rotor blades. The trailing edge segment 112, 112′ is subdivided into a plurality of segment portions, as can be seen in detail from the following FIGS. 2 and 3.

In FIG. 2, the rotor blade 108 is illustrated with a trailing edge segment 112 according to a first exemplary embodiment. The rotor blade 108 illustrated in FIG. 2 has, in an inner blade portion 2 adjoining the rotor blade root 1, the trailing edge segment 112 which prolongs the profile depth of the rotor blade. The trailing edge segment 112 has a suction-side surface 4 and a pressure-side surface 6 which are separated from one another by a trailing edge 8 on the trailing edge segment 112.

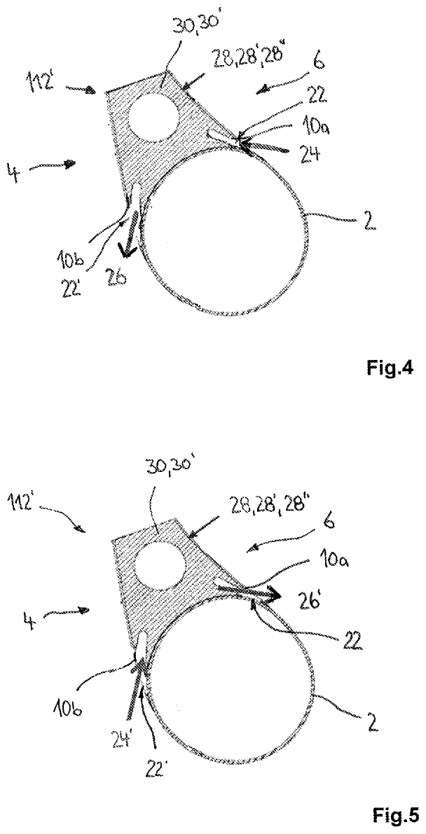

Arranged opposite to the trailing edge 8 is the connection side of the trailing edge segment 112 to the inner blade portion 2 of the rotor blade 108. Extending on the connection side is a first edge 10a and a second edge 10b (see FIG. 4) which delimits the suction-side and pressure-side surface 4, 6 of the trailing edge segment 112. The edges 10a, 10b are adapted to the curvature of the rotor blade 108 and extend substantially in the rotor blade longitudinal direction. In the mounted state, the trailing edge 8 of the trailing edge segment 112 is aligned with and merges seamlessly into the trailing edge 12 of the region of the rotor blade 108 that adjoins the inner blade portion 2.

In the present embodiment, the trailing edge segment 112 has a segment portion 14 which is formed as a foot segment and which has the connection side to the inner blade portion 2. The trailing edge segment 112 has the foot segment 14 having the connection side and has two segment portions 16, 18 coupled to the foot segment 14 and forming head segments. The two head segments 16, 18 each form a part of the trailing edge 8 of the trailing edge segment 112. The head segments 16, 18 are separated from the foot segment 14 in subdividing planes 20, 20′ extending approximately parallel to the rotor blade longitudinal axis.

In the embodiment shown, the edge 10a terminates on the foot segment 14 of the trailing edge segment 112 at a spacing from the outer surface or outer contour of the inner blade portion 2, with the result that a gap 22 is formed between the pressure-side surface 6 of the trailing edge segment 112 and of the inner blade portion 2. Suctioning or blowing out of the boundary layer is possible on the pressure-side surface 6 of the rotor blade 108 via the gap 22 which is formed in the transition region from the inner blade portion 2 to the trailing edge segment 112. An air inlet 24 for letting air into the interior or an air outlet 26 for letting air out of the interior of the trailing edge segment 112 is preferably formed via the gap 22.

In one embodiment of the invention that is not shown more precisely, alternatively or optionally the edge 10b is likewise arranged at a spacing from the outer structure of the inner blade portion 2 on the suction-side surface 4 of the rotor blade 108, and thus a gap 22′ is present. The gap 22′ forms, alternatively, an air inlet 24′ or, optionally, an air inlet 24′ or air outlet 26. The flowing-past air flow on the suction-side surface 4 of the rotor blade 108 is likewise influenced via the air inlet 24′ or the air outlet 26′.

FIG. 3 shows a second embodiment of a rotor blade 108, in which a trailing edge segment 112′ is arranged on the inner blade portion 2 of the rotor blade 108 in the root region of the rotor blade. By contrast with the trailing edge segment 112, the trailing edge segment 112′ is formed from a plurality of segment portions 28, 28′, 28″ which are arranged adjacent to one another and next to one another on the inner blade portion 2 in the rotor blade longitudinal direction. The trailing edge segment 112′ composed of the segment portions 28, 28′ also has an edge 10a, 10b which is arranged at a spacing from the outer structure of the inner blade portion 2.

In a preferred embodiment, slot-shaped air inlets and/or air outlets 24, 24′, 26, 26′ in the form of a gap 22, 22′ are thus formed on the suction-side surface 4 and the pressure-side surface 6 of the rotor blade 108 shown in FIG. 3. In one embodiment, a respective gap 22, 22′ formed on the rotor blade 108 can be continuous on the trailing edge segment 112, 112′. In the present case, the gap 22 is formed in the transition region between the inner blade portion 2 and the trailing edge segment 112′. In another embodiment, the gap 22, 22′ has a plurality of individual gaps which are arranged behind one another substantially in a row and extend approximately parallel to the rotor blade longitudinal axis. The air inlets 24, 24′ or the air outlet 26, 26′ are also formed on the suction-side surface 4 and the pressure-side surface 6 of the rotor blade 108 in the transition region between the inner blade portion and the trailing edge section 112′.

FIG. 4 shows the embodiment of the rotor blade 108 from FIG. 3 in section.

The trailing edge segment 112′ is arranged on the inner blade portion 2 by means of a plurality of fastening elements 30, 30′. In the embodiment shown, the inner blade portion 2 has an approximately annular or elliptical cross section, wherein the cross-sectional shape of the inner blade portion 2 changes in dependence on the spacing of the inner blade portion from the blade root. In the embodiment of the trailing edge segment 112′ that is shown in FIG. 3, each segment portion 28, 28′, 28″ is fastened to the inner blade portion of the rotor blade 108 via at least two fastening elements 30, 30′.

FIG. 4 particularly illustrates the embodiment of the invention in which boundary layer influencing of the air flow flowing along on both sides of the rotor blade 108 occurs without a targeted influencing by additional measures. By virtue of the pressure which is statically higher on the pressure-side surface 6 than on the suction-side surface 4 of the rotor blade 108, and the resulting pressure difference between the pressure side and the suction side of the rotor blade 108, there occurs a naturally generated air flow (compensating flow) through the trailing edge segment 112′ from the pressure side of the rotor blade to the suction side of the rotor blade via the gap 22, 22′. In the embodiment shown, the gap 22 forms the air inlet 24 on the pressure side, and the gap 22′ forms the air outlet 26 on the suction side. Consequently, the air flow is suctioned on the pressure-side surface of the rotor blade 108 and blown out on the suction-side surface 4 of the rotor blade 108. Blowing out the air flow on the suction-side surface 4 of the rotor blade is intended to stabilize the air flow flowing past there and to avoid turbulence in particular in the rear region of the rotor blade 108, that is to say on the trailing edge segment. In the embodiment shown in FIG. 4, the air flow is blown out on the suction side counter to the actual flow direction of the air flowing past along the blade profile.

In one embodiment (not shown), the air outlet 26 is arranged in such a way that the air blown out of the trailing edge segment 112′ via the air outlet flows out approximately in the direction of the air flowing along the blade profile.

In FIG. 5, the rotor blade 108 with its inner blade portion 2 and its trailing edge segment 112′ arranged thereon is again illustrated in section. Contrary to the embodiment shown in FIG. 4, the rotor blade 108 in FIG. 5 comprises a fan or compressor (not shown in more detail) which is arranged within the trailing edge segment 112′. The fan or compressor generates a forced air flow within the trailing edge segment 112′, it being the case, by contrast with the previously described embodiment, that the air inlet 24′ is now situated on the suction-side surface 4 of the rotor blade 108 and the air outlet 26′ is situated on the pressure-side surface 6 of the rotor blade 108. Suctioning the air flow on the suction side of the rotor blade 108 via the air inlet 24′ counteracts thickening of the boundary layer in the region of the trailing edge section 112′ of the rotor blade. The air flow suctioned on the suction side is blown out via the air outlet 26′ on the pressure-side surface 6 of the rotor blade by means of the fan or compressor in the trailing edge segment 112′. In the embodiment shown in FIG. 5, suctioning occurs in the direction of the air flowing past the rotor blade, and blowing out occurs counter to the flow direction of the air flowing past the rotor blade. In one embodiment (not shown in more detail), air inlet ducts connected to the air inlet 24′ are arranged in the trailing edge segment. In a further embodiment, air outlet ducts connected to the air outlet 26′ are provided in the trailing edge segment. In another embodiment of the invention which is not illustrated in more detail, air-channeling ducts are arranged within the trailing edge segment 112′, said ducts producing the connection between air inlet and air outlet and extending at least in certain portions parallel to the rotor blade longitudinal direction.

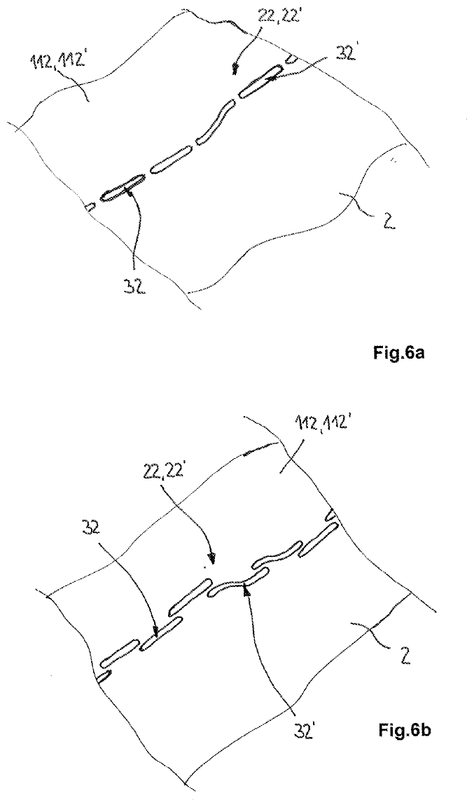

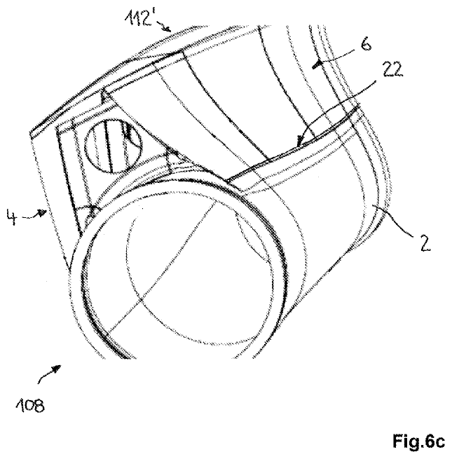

FIGS. 6a to 6c show possible embodiments of the air inlets 24, 24′ and/or air outlets 26, 26′ which are preferably formed in a transition region from the inner blade portion 2 to the trailing edge segment 112, 112′ in the suction-side surface 4 and/or the pressure-side surface 6 of the rotor blade 108. The air inlet or the air outlet 24, 24′, 26, 26′ has the shape of a slot or gap 22, 22′. The gap 22, 22′ can be formed from a plurality of individual gaps 32, 32′ which, in the embodiment shown in FIG. 6a, are arranged behind one another in a row, wherein the individual gaps 32, 32′ extend substantially parallel to the rotor blade longitudinal direction.

In the embodiment shown in FIG. 6b, the gap 22, 22′ is formed from a plurality of individual gaps 32, 32′ which likewise extend substantially in the rotor blade longitudinal direction. By contrast with the embodiment shown in FIG. 6a, individual gaps directly adjacent to one another are arranged offset to one another transversely to the rotor blade longitudinal direction, that is to say in the profile depth, and have an overlapping in their end regions. The overlapping corresponds approximately to a dimension of approximately one fifth of the length of an individual gap 32, 32′. Other overlapping ratios are possible. The embodiment shown in FIG. 6b achieves an enlarged cross section of the air inlet and/or air outlet 24, 24′, 26, 26′ on the suction-side or pressure-side surface 4, 6 of the rotor blade with an identical overall length of the gap 22, 22′ in the transition region between the inner blade portion 2 and the trailing edge segment 112, 112′.

FIG. 6c shows a schematic illustration of a portion of the rotor blade 108. The rotor blade 108 has, on the suction-side and pressure-side surface 4, 6, a continuous gap 22 which, in the presently illustrated embodiment, extends over the entire length of the trailing edge segment 112′. As illustrated in FIG. 6c, the gap 22 for air inlet or air outlet is formed directly in the surface of the trailing edge segment 112′. Instead of the continuous gap 22, the gaps 22′ with their plurality of individual gaps 32, 32′ as shown in FIGS. 6a and 6b can also be provided on the rotor blade.

### LIST OF REFERENCE SIGNS

1 Blade root
2 Inner blade portion
4 Suction-side surface
6 Pressure-side surface
8 Trailing edge
10a, b Edge
12 Trailing edge
14 Foot segment
16, 18 Head segment
20, 20′ Subdividing plane
22, 22′ Gap
24, 24′ Air inlet
26, 26′ Air outlet
28, 28′, 28″ Segment portion
30, 30′ Fastening element
32, 32′ Individual gap
100 Wind turbine
102 Tower
104 Nacelle
106 Rotor
108 Rotor blade
110 Spinner
112, 112′ Trailing edge segment

1. A rotor blade for a wind turbine, comprising:
an inner blade portion which extends in a longitudinal direction of the rotor blade starting from a rotor blade root;
a trailing edge segment arranged on the inner blade portion, wherein the trailing edge segment increases a profile depth of a portion of the rotor blade;
a pressure-side surface and a suction-side surface which are each formed in part from the inner blade portion and the trailing edge segment; and
at least one of: air inlet or air outlet at the pressure-side surface or the suction-side surface of the trailing edge segment and extending substantially in the longitudinal direction of the rotor blade.

2. The rotor blade as claimed in claim 1, comprising both the air inlet and the air outlet, wherein the air inlet and the air outlet are arranged on respective sides of the pressure-side surface and the suction-side surface of the rotor blade.

3. The rotor blade as claimed in claim 1, wherein the air inlet and the air outlet are located in a transition region between the inner blade portion and the trailing edge segment.

4. The rotor blade as claimed in claim 2, wherein the air inlet is arranged on the pressure-side surface of the rotor blade, and the air outlet is arranged on the suction-side surface of the rotor blade.

5. The rotor blade as claimed in claim 1, wherein the at least one of: air inlet or air outlet extends substantially over an entire length of the trailing edge segment.

6. The rotor blade as claimed in claim 2, wherein the trailing edge segment is arranged on the inner blade portion in such a way that an air inlet duct and an air outlet duct for a directed air flow are formed on the air inlet and the air outlet, respectively.

7. The rotor blade as claimed in claim 6, wherein the air inlet duct and the outlet duct are configured to direct the air flow in a region of the air inlet and the air outlet substantially parallel to respectively adjoining outer surface of the inner blade portion.

8. The rotor blade as claimed in claim 2, further comprising a fan or compressor, wherein the air inlet and the air outlet are in fluid communication with the fan or compressor to provide forced air guidance through the trailing edge segment.

9. The rotor blade as claimed in claim 8, wherein the fan or compressor is arranged in the inner blade portion of the rotor blade.

10. The rotor blade as claimed in claim 8, wherein the fan or compressor is arranged in the trailing edge segment of the rotor blade.

11. The rotor blade as claimed in claim 1, wherein the trailing edge segment comprises a first segment portion and a second segment portion.

12. The rotor blade as claimed in claim 1, wherein the trailing edge segment is connected to the inner blade portion by a first fastening element and a second fastening element.

13. The rotor blade as claimed in claim 12, wherein at least one of the first or second fastening elements has at least one ribbed body configured to stiffen the trailing edge segment.

14. A wind turbine comprising:
a tower;
a nacelle;
a rotor; and
at least one rotor blade as claimed in claim 1, wherein the at least one rotor blade is coupled to the rotor.

15. A wind farm comprising a plurality of wind turbines as claimed in claim 14.

16. The rotor blade as claimed in claim 9, wherein the inner blade portion has at least one of: air passage openings or air-channeling ducts that provide the fluid communication between the fan or the compressor and the air inlet and the air outlet.

17. The rotor blade as claimed in claim 12, wherein the first and second fastening elements are arranged at spacings from one another in the rotor blade longitudinal direction.

18. The rotor blade as claimed in claim 13, wherein the ribbed body is connected to an outer surface of the inner blade portion and to an inner side of the trailing edge segment by one or more fasteners.
